(19) United States
(12) Patent Application Publication
(10) Pub. No.: US 2019/0366944 A1
(43) Pub. Date: Dec. 5, 2019

(54) RIB CLIP ASSEMBLY

(71) Applicant: ILLINOIS TOOL WORKS INC., Glenview, IL (US)

(72) Inventors: Weibin Liu, Shanghai (CN); Jeffrey Steltz, Chippewa Falls, WI (US)

(21) Appl. No.: 16/480,042

(22) PCT Filed: Jan. 18, 2018
(86) PCT No.: PCT/US2018/014125

§ 371 Date: Jul. 23, 2019

Related U.S. Application Data
(60) Provisional application No. 62/456,157, filed on Feb. 8, 2017.

(51) Int. Cl. B60R 13/02; F16B 21/07; F16B 5/06

(52) U.S. Cl. CPC B60R 13/0206; F16B 5/065; F16B 21/075

(57) ABSTRACT

A retaining clip includes a nose. The retaining clip includes opposing beams extending from the nose. The opposing beams have an oblong shape. The opposing beams form compression regions. Retaining legs extend from the compression regions. The retaining legs are configured to be spaced apart from each other.

### RELATED APPLICATIONS

This application relates to and claims priority benefits from U.S. Provisional Patent Application No. 62/456,157, entitled “RIB CLIP ASSEMBLY,” filed Feb. 8, 2017, which is hereby incorporated by reference in its entirety.

### FIELD OF EMBODIMENTS OF THE DISCLOSURE

Embodiments of the present disclosure relate to rib clip assemblies.

### BACKGROUND

Various components are secured together through fastener assemblies. For example, panels, sheets, frames, or the like can be secured together through fastener assemblies that include a male fastening member that securely mates with a female fastening member.

A fastener assembly such as a clip may be used to secure a first component (such as trim molding) to a second component (such as sheet metal). A male fastening member may be urged into a slot of a panel, for example. Fastener assemblies are shown and described in U.S. Pat. No. 9,303,665, entitled “Adaptable Mating Fastener Assembly,” which is hereby incorporated by reference in its entirety. Additionally, United States Patent Application Publication No. 2015/0026933, entitled “Clips,” discloses a clip having a main clip body that is configured to be inserted into an installing hole of a panel and mount to a clip seat. U.S. Pat. No. 6,796,006, entitled “Rib Clip,” which is hereby incorporated by reference in its entirety, discloses a retaining clip including a U-shaped body having a pair of legs that are flexibly connected at their bottom ends and spaced apart to receive therebetween a blade fastener.

Certain known fastener assemblies are configured for use with a rectangular hole, which includes a molding weld line. Legs of the rib clip include protuberances that extend into the retaining hole to securely couple a retaining clip to the rib member. However, forces on the hole edge may cause a fracture in a weld line. For example, the weld line forms a weakened area, which may be susceptible to splitting responsive to removal of the rib clip assembly from the component.

### SUMMARY OF EMBODIMENTS OF THE DISCLOSURE

As suggested above, a need exists for a robust and reliable retaining clip.

With that need in mind, certain embodiments of the present disclosure provide a retaining clip. A retaining clip includes a nose. Opposing beams extend from the nose of the retaining clip. The opposing beams having an oblong shape. The opposing beams forming compression regions. The retaining clip includes retaining legs extending from the compression regions. The retaining legs are configured to be spaced apart from each other. Optionally, the retaining legs extend towards the nose.

Optionally, the retaining legs include receptacle indentations. The receptacle indentations including orthogonal angles cutouts at distal ends of the retaining legs. Additionally or alternatively, the receptacle indentations are configured to be received by retaining holes of a rib member. Optionally, the receptacle indentations reach the retaining holes of the rib member responsive to the retaining legs traversing along the rib member. Additionally or alternatively, the retaining holes are offset relative to a centerline of the rib member. Optionally, the rib member includes weld lines that extend diagonally from an upper lateral portion of the retaining holes to an edge of the rib clip. Optionally, the weld lines are configured such that extraction forces of the retaining legs are not exerted on the weld lines.

Optionally, the retaining clip includes stoppers disposed along an internal face of the opposing beams. The stoppers are configured to abut an edge of a rib member. Additionally or alternatively, in response to the retaining legs traversing along a rib member the retaining legs are compressed by the rib member. Optionally, the retaining legs are removed from retaining holes of a rib member in response to vector forces applied away from the centerline.

In an embodiment, a rib clip assembly is provided. The rib clip assembly includes a retaining clip. The retaining clip includes a nose and opposing beams extending from the nose. The opposing beams having an oblong shape. The opposing beams forming compression regions interposed between first and second protrusions. Extending from the second protrusions are retaining legs. The retaining legs are configured to be spaced apart from each other. The rib clip assembly includes a rib member that includes retaining holes offset relative to a centerline of the rib member. The rib member includes weld lines that extend diagonally from an upper lateral portion of the retaining holes to an edge of the rib member.

Optionally, the retaining legs of the retaining clip include a support connection that couples the retaining legs to the nose. Additionally or alternatively, stoppers are disposed on the support connection. The stoppers are configured to abut the edge of the rib member.

Optionally, stoppers extend from the nose of the retaining clip. The stoppers are configured to abut the edge of the rib member. Additionally or alternatively, the retaining legs include receptacle indentations that are configured to enter the retaining holes of the rib member. Optionally, the receptacle indentations include an extension extending along a width of the rib member. Optionally, the retaining legs are compressed by the rib member in response to the retaining legs traversing along the rib member. Optionally, the retaining legs are removed from retaining holes of the rib member in response to vector forces applied away from the centerline.

### BRIEF DESCRIPTION OF SEVERAL VIEWS OF THE DRAWINGS

FIG. 1 illustrates a lateral perspective view of a retaining clip, according to an embodiment of the present disclosure.

FIG. 2 illustrates a frontal view of a rib member, according to an embodiment of the present disclosure.

FIG. 3 illustrates a lateral view of a rib clip assembly traversing along a rib member, according to an embodiment of the present disclosure.

FIG. 4 illustrates a lateral view of a rib clip assembly, according to an embodiment of the present disclosure.

FIG. 5 illustrates a lateral view of a rib clip assembly having forces applied to compression regions, according to an embodiment of the present disclosure.

FIG. 6 illustrates a lateral view of a retaining clip, according to an embodiment of the present disclosure.

FIG. 7 illustrates a lateral perspective view of a retaining clip, according to an embodiment of the present disclosure.

FIG. 8 illustrates a lateral perspective view of a retaining clip, according to an embodiment of the present disclosure.

FIG. 9 illustrates a lateral view of a rib clip assembly, according to an embodiment of the present disclosure.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

Embodiments of the present disclosure provide a retaining clip having four retaining legs. The four retaining legs are configured to be retained in retaining holes of a rib member. Distal ends of the four retaining legs can include indentations. The indentations are configured to compress the four retaining legs within the retaining holes. The retaining holes of the rib member are offset from a centerline and include diagonal welds. The weld lines extend diagonally from an upper lateral portion of the two retainer holes to an edge of the rib member. The two weld lines are configured to disperse the extraction force such that the extraction force is not directed onto the weld lines.

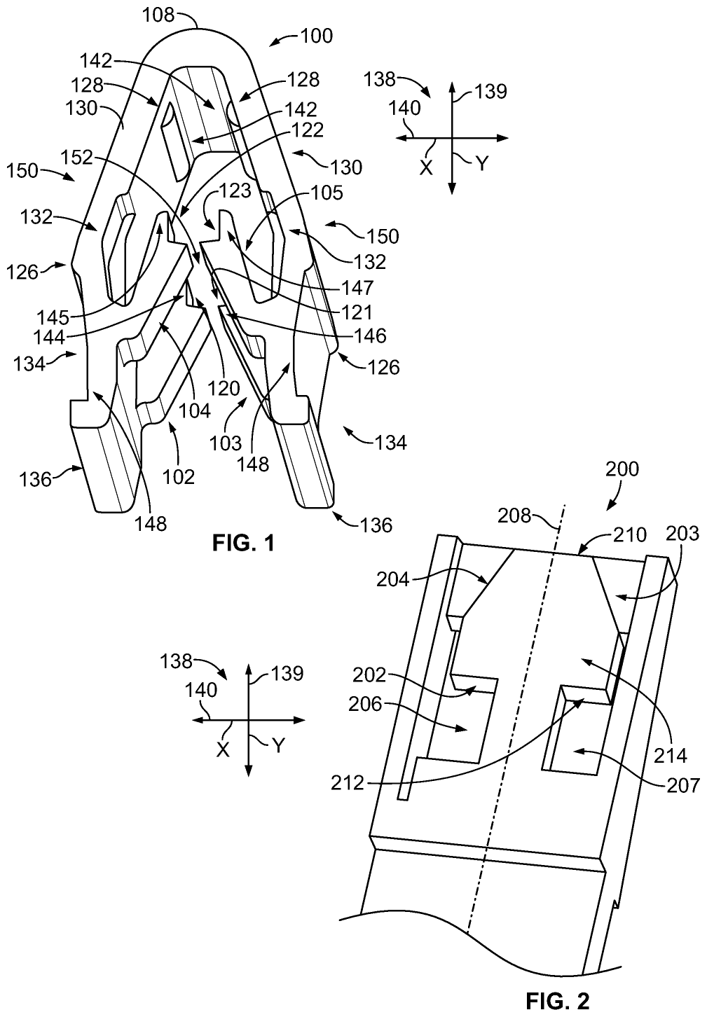

FIG. 1 illustrates a lateral perspective view of a retaining clip 100, according to an embodiment of the present disclosure. The retaining clip 100 includes a nose 108. Extending from the nose 108 are opposing beams 130. The beams 130 extend outwardly relative to and/or from the nose 108. The beams 130 are shown having an oblong shape. For example, the beams 130 are shown extending further along a Y-direction 139 relative to an X-direction 140 of Cartesian coordinates 138. The oblong shape of the beams 130 allows the retaining clip 100 to extend along a rib member 200 (shown in FIG. 2). For example, the oblong shape of the beams 130 enables the retaining clip 100 to traverse along the Y-direction 139 towards retaining holes 206, 207 of the rib member 200.

Along with an internal face 142 of the beams 130 are stoppers 128 and indentations 132. For example, the stoppers 128 are disposed along the internal face 142 of the beams 130. The stoppers 128 are configured to abut an edge 210 of the rib member 200 (shown in FIG. 2). For example, the stoppers 128 are configured to abut the retaining clip 100 to prevent vibration rattling.

The beams 130 extend from the nose 108 to form compression regions 134 interposed between retention edges 126 and 136. Extending from the regions 134 are retaining legs 102-105. The legs 102-105 are spaced apart from each other and directed and/or extend toward the nose 108. For example, distal ends 144-147 of the legs 102-105 extend towards the nose 108. The legs 102-105 are directed laterally away from the regions 134. For example, the legs 102-105 are directed diagonally relative to the X-direction 140 and the Y-direction 139 towards the nose 108. The legs 102-105 are separated from each other by a distance 152.

At the distal ends 144-147 of the legs 102-105 are receptacle indentations 120-123. The indentations 120-123 provide L-shaped cutouts and/or orthogonal angles cutouts at distal ends 144-147 of the legs 102-105. The indentations 120-123 are configured to be received by and/or enter the holes 206, 207 of the rib member 200 (shown in FIG. 2). The L-shaped cutouts and/or orthogonal angles cutouts of the indentations 120-123 lock the retaining clip 100 to the rib member 200. Responsive to the indentations 120-123 within the holes 206, 207, the indentations 120-123 are secured to the rib member 200 to form the rib clip assembly. For example, the indentations 120-123 enable the legs 102-105 to be coupled to the rib member 200.

Surface areas 148 of the regions 134 are curved. The curved surface areas 148 allow an operator to apply pressure at the regions 134 directed towards the legs 102-105, which allow the retaining clip 100 to be removed from the rib member 200. For example, responsive to forces applied at the regions 134, the indentations 120-123 of the legs 102-105 are retracted from the holes 206, 207. The retraction of the indentations 120-123 from the holes 206, 207, prevents the legs 102-105 from being obstructed by the holes 206, 207. The retraction of the indentations 120-123 from the holes 206, 207 enables the retaining clip 100 to be removed from the rib member 200.

FIG. 2 illustrates a frontal view of the rib member 200, according to an embodiment of the present disclosure. Optionally, the rib member 200 is coupled to panels, sheets, frames, or like. Referring to FIGS. 1 and 2, a rib clip assembly is formed by the retaining clip 100 coupled to the rib member 200. The retaining clip 100 is configured to be coupled to the rib member 200. For example, the indentations 120-123 of the legs 102-105 enter the holes 206, 207, which couple the retaining clip 100 to the rib member 200.

The rib member 200 includes the holes 206, 207. The holes 206, 207 are offset relative to a centerline 208. The centerline 208 traverses through a middle of the rib member 200. The holes 206, 207 are shifted and/or offset relative to the centerline 208. The holes 206, 207 are configured to allow the indentations 120-123 of the legs 102-105 to enter the holes 206, 207. The holes 206, 207 include receptacle sides 202, 212 that extend towards an edge 210. The sides 202, 212 represent the edges of the holes 206, 207. The sides 202, 212 are configured to receive the indentations 120-123 as the retaining clip 100 traverses along the rib member 200 in the Y-direction 139.

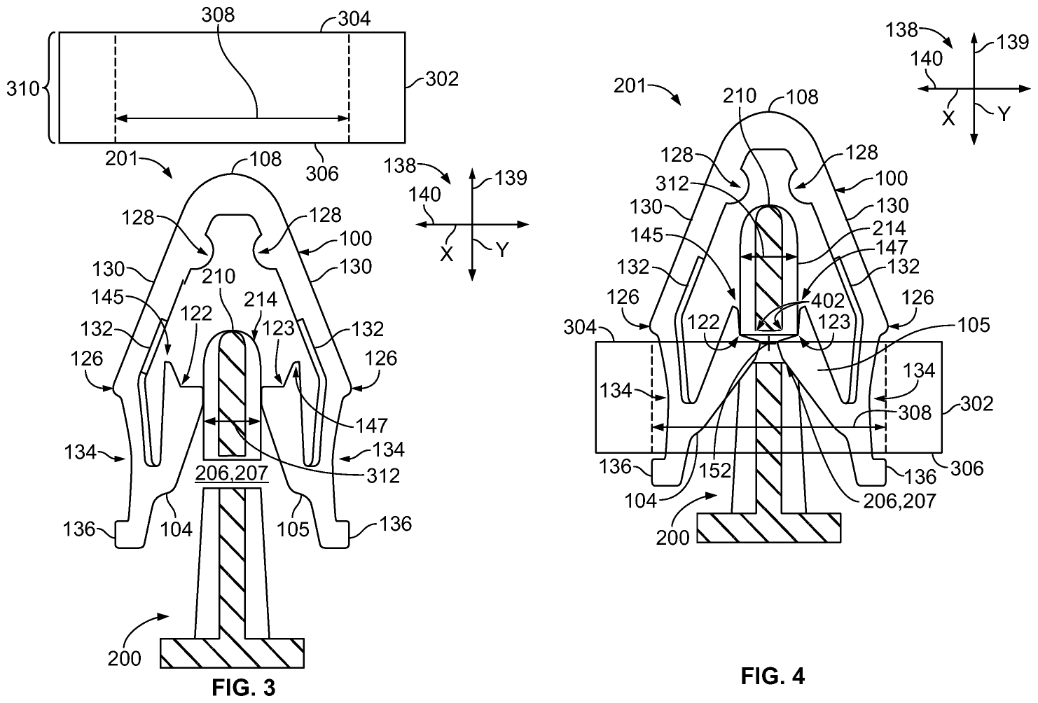

The rib member 200 includes weld lines 203, 204. The weld lines 203, 204 extend diagonally from an upper lateral portion of the two retaining holes 206, 207 to the edge 210 of the rib member 200. The weld lines 203, 204 descend away (e.g., at an angle) from the centerline 208 from the edge 210 to the receptacle sides 202, 212 of the holes 206, 207. Responsive to the removal of the rib clip assembly 201 from a component 302 (shown in FIG. 3), the extraction forces are not exerted on the rib member 200 and are not directed on the weld lines 203, 204. For example, the angle of the weld lines 203, 204 absorbs extraction forces along the X and Y directions 139, 140 of the retaining clip 100 from the rib member 200. As the extraction forces are not directed on the weld lines 203, 204 of the rib member 200, the rib member 200 is not susceptible to breaking.

FIG. 3 illustrates a lateral view of a rib clip assembly 201, according to an embodiment of the present disclosure. The retaining clip 100 and the rib member 200 provide the rib clip assembly 201. The retaining clip 100 is positioned over the rib member 200. The oblong shape of the beams 130 allows the rib member 200 to be positioned between the beams 130. For example, the beams 130 provide a separation of the regions 134, which allow the rib member 200 to traverse towards the nose 108. Responsive to the retaining clip 100 traversing along the rib member 200 along the Y-direction 139 towards the holes 206, 207, the legs 102-105 are compressed by the panel 214. For example, the legs 102-105 are not aligned with the holes 206, 207. Instead, the legs 102-105 are in direct contact with the panel 214. A width 312 of the rib member 200 is wider than the distance 152 between the legs 102-105 (FIG. 1). Based on the difference between the distance 152 and the width 312, the rib member 200 applies forces onto the legs 102-105. For example, the width 312 of the panel 214 applies the forces onto the legs 102-105 along the X-direction 140, thereby separating the legs 102-105 with respect to each other. The forces exerted from the panel 214 onto the legs 102-105 compress the legs 102-105 away from the rib member 200.

Additionally, the component 302 may be or include a sheet metal and/or a plastic panel. Optionally, more than one panel may be utilized. The component 302 includes an opening, such as a slot or window 308. The window 308 may be rectangular in shape and have dimensions that are complementary to the retaining clip 100. For example, the dimensions of the window 308 are configured to allow the retaining clip 100 to pass through the window 308 along the Y-direction 139. A thickness 310 of the component 302 is configured to be between the retention edges 126 and 136. The component 302 includes an upper surface 304 and an undersurface 306.

FIG. 4 illustrates a lateral view of the rib clip assembly 201, according to an embodiment of the present disclosure. The indentations 120-123 of the retaining clip 100 are positioned within the holes 206, 207 of the rib member 200. For example, the indentations 120-123 have the L-shape cutouts, which are configured to be received by the holes 206, 207. The L-shape cutouts of the indentations 120-123 represent orthogonal angles cutouts of the legs 102-105. For example, the indentations 120-123 include planes 402 aligned along the X and Y directions 140, 139.

Responsive to the retaining clip 100 traversing along the Y-direction 139, the indentations 120-123 reach the sides 202, 212 (FIG. 2) of the holes 206, 207. The sides 202, 212 correspond to a portion of the rib member 200 that is less than the width 312. Responsive to the indentations 120-123 reaching the sides 202, 212, the indentations 120-123 expand and/or are received by the holes 206, 207. For example, as the indentations 120-123 are in contact with the panel 214, the legs 102-105 are compressed based on the difference between the width 312 and the distance 150. When the indentations 120-123 reach the sides 202, 212, the planes 402 are not obstructed by the panel 214. For example, the sides 202, 212 allow the legs 102-105 to expand within the holes 206, 207 and return to the distance 152.

The planes 402 of the indentations 120-123 extend within the holes 206, 207. Additionally, the L-shape cutouts of the indentations 120-123 extend along the X and Y directions 140, 139 along the panel 214 of the rib member 200. The indentations 120-123 may prevent motion of the retaining clip 100 relative to the rib member 200. For example, the L-shape cutouts of the indentations 120-123 extend within the holes 206, 207 and along the panel 214 of the rib member 200. The dual direction of the indentations 120-123 along the X-direction 140 and the Y-direction 139 is configured to prevent lateral and/or vertical motion of the retaining clip 100 relative to the rib member 200. For example, the indentations 120-123 are configured to couple the retaining clip 100 to the rib member 200 to form the rib clip assembly 201. Additionally, the component 302 is shown positioned between the retention edges 126 and 136. For example, the window 308 of the component 302 traverses through the nose 108 of the retention clip 100 along the Y-direction 139. The component 302 is positioned between the retention edges 126 and 136. Additionally or alternatively, the stoppers 128 are configured to abut the edge 210 of the rib member 200 to prevent vibration rattling.

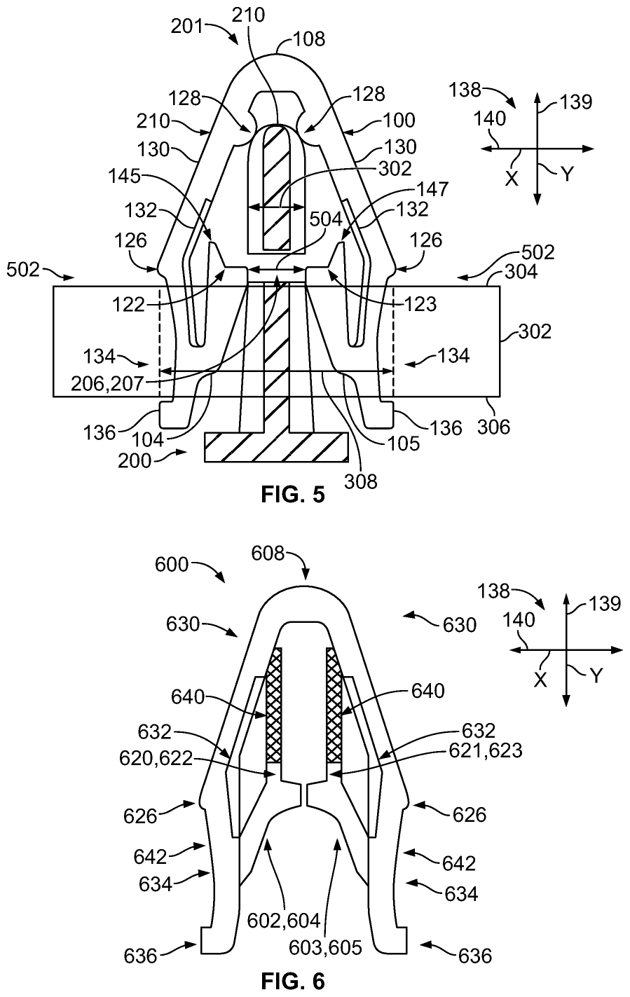

FIG. 5 illustrates a lateral view of the rib clip assembly 201 having forces applied to the retention edge 126. Vector forces 502 are shown along the X-direction 140 and result from the extraction of the rib clip assembly 201 from the rib clip 200 and the component 302. Optionally, the forces 502 can be directed along the Y-direction 139. The forces 502 are shown directed at the retention edge 126. For example, the forces 502 are directed towards each other along opposing directions along the X-direction 140. Responsive to the forces 502, the beams 130 retract from the hole 308 of the component 302. For example, the forces 502 compress the retention edge 126 towards each other along the X-direction 140. The forces 502 compress the beams 130 toward the centerline 208 of the rib member 200. For example, the legs 104-105 come out of the holes 206, 207.

Responsive to the removal of the rib clip assembly 201 from the component 302, the extraction forces exerted on the rib member 200 are not directed on the weld lines 203, 204. For example, the angle of the weld lines 203, 204 absorbs extraction forces along the X and Y directions 139, 140 of the retaining clip 100 from the rib member 200.

FIG. 6 illustrates a lateral view of a retaining clip 600, according to an embodiment of the present disclosure. The retaining clip 600 includes a nose 608. Extending from the nose 608 are opposing beams 630. The beams 630 extend outwardly relative to the nose 608. The beams 630 are shown having an oblong shape. For example, the beams 630 are shown extending further along the Y-direction 139 relative to the X-direction 140 of the Cartesian coordinates 138. The oblong shape of the beams 630 allows the retaining clip 200 to extend along the rib member 200 (FIG. 2). For example, the oblong shape of the beams 630 allows the rib member 200 to enter the retaining clip 200.

The beams 630 extend to form compression regions 634. Interposed between the protrusions 626 and protrusions 636 is the compression regions 634. Extending from the regions 634 are the legs 602-605. The legs 602-605 are spaced apart from each other and directed towards the nose 608. For example, the legs 602-605 are directed laterally away from the regions 634. The legs 602-605 are directed diagonally relative to the X-direction 140 and the Y-direction 139 towards the nose 608.

The legs 602-605 include receptacle indentations 620-623. The indentations 620-623 represent L-shaped cutouts and/or orthogonal cutouts of the legs 602-605. The indentations 620-623 are configured to enter the holes 206, 207 of the rib member 200 (FIG. 2). For example, the indentations 620-623 are configured to be positioned within the holes 206, 207. Responsive to the indentations 620-623 within the holes 206, 207, the indentations 620-623 are secured to the rib member 200 for form a rib clip assembly. For example, the indentations 620-623 enable the legs 602-605 to be coupled to the rib member 200.

The legs 602-605 include support connections 640 that couple the legs 602-605 to the nose 608. The connections 640 extend upwards along the Y-direction 139 toward the nose 608. For example, the connections 640 include an integral coupling or support connection between the legs 602-605 and the nose 608.

Surface areas 642 of the regions 634 are curved. For example, responsive to opposing forces applied at the regions 634 away from the centerline 208 of the rib member 200, the indentations 620-623 of legs 602-605 are retracted from the holes 206, 207. The forces are directed towards the regions 634 along the X-direction 140, which expand the legs 602-605 apart from each other. The forces further retract the connections 640, thereby increasing a distance between the legs 602-605 and the connections 640. The increased distance of the legs 602-605 from the holes 206, 207 prevent the legs 602-605 from being obstructed by the holes 206, 207. The retraction of the indentations 620-623 from the holes 206, 207 allows the retaining clip 200 to be removed from the rib member 200.

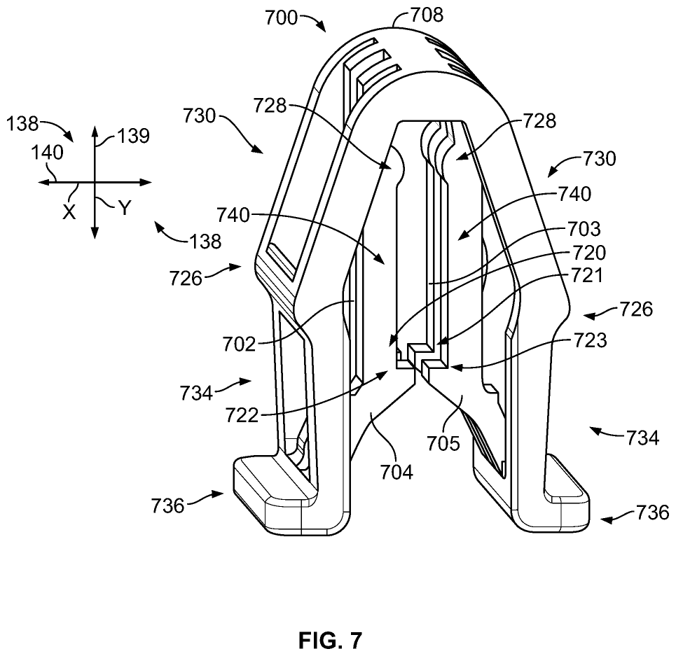

FIG. 7 illustrates a lateral perspective view of a retaining clip 700, according to an embodiment of the present disclosure. The retaining clip 700 includes a nose 708. Extending from the nose 708 are opposing beams 730. The beams 730 extend outwardly relative to the nose 708. The beams 730 are shown having an oblong shape. For example, the beams 730 are shown extending further along a Y-direction 139 relative to the X-direction 140 of the Cartesian coordinates 138. The oblong shape of the beams 730 allows the retaining clip 700 to extend along the rib member 200 (FIG. 2). For example, the oblong shape of the beams 730 allows the rib member 200 to enter the retaining clip 700.

The beams 730 extend to form compression regions 734. Interposed between the protrusions 726 and protrusions 736 are the compression regions 734. Extending from the protrusions 736 are the legs 702-705. The legs 702-705 are spaced apart from each other and directed towards the nose 708. For example, the legs 702-705 are directed laterally away from the protrusions 736. For example, the legs 702-705 are directed diagonally relative to the X-direction 140 and the Y-direction 139 towards the nose 708.

The legs 702-705 include receptacle indentations 720-723. The indentations 720-723 represent L-shaped cutouts and/or orthogonal angle cutouts of the legs 702-705. The indentations 720-723 are configured to enter the holes 206, 207 of the rib member 200 (FIG. 2). For example, the indentations 720-723 are configured to be positioned within the holes 206, 207. Responsive to the indentations 720-723 moving into the holes 206, 207, the indentations 720-723 are secured to the rib member 200 to form the rib clip assembly 701 (shown in FIG. 9). For example, the indentations 720-723 enable the legs 702-705 to be coupled to the rib member 200.

The legs 702-705 include support connections 740 that couple the legs 702-705 to the nose 708. The connections 740 extend upwards along the Y-direction 139 toward the nose 708. For example, the connections 740 include an integral coupling or support connection between the legs 702-705 and the nose 708.

Disposed along the connections 740 are stoppers 728. The stoppers 728 are configured to abut the edge 210 of the rib member 200 (FIG. 2) to prevent vibration rattling. Optionally, the stoppers 728 are configured to extend along a height of the connections 740.

The regions 734 allow the retaining clip 700 to be removed from the rib member 200. For example, responsive to forces applied away from the centerline 208 along the X-direction 140 at the regions 734, the indentations 720-723 of the legs 702-705 are retracted from the holes 206, 207. The opposing forces expand the legs 702-705 apart from each other. The connections 740 separate with respect to each other with the legs 702-705. For example, a distance between the legs 702-705 is expanded outside the width 312 of the rib member 200. The spacing of the legs 702-705 from the holes 206, 207 allow the legs 702-705 not to be obstructed by the holes 206, 207. The retraction of the indentations 720-723 from the holes 206, 207 enable the retaining clip 700 to be removed from the rib member 200.

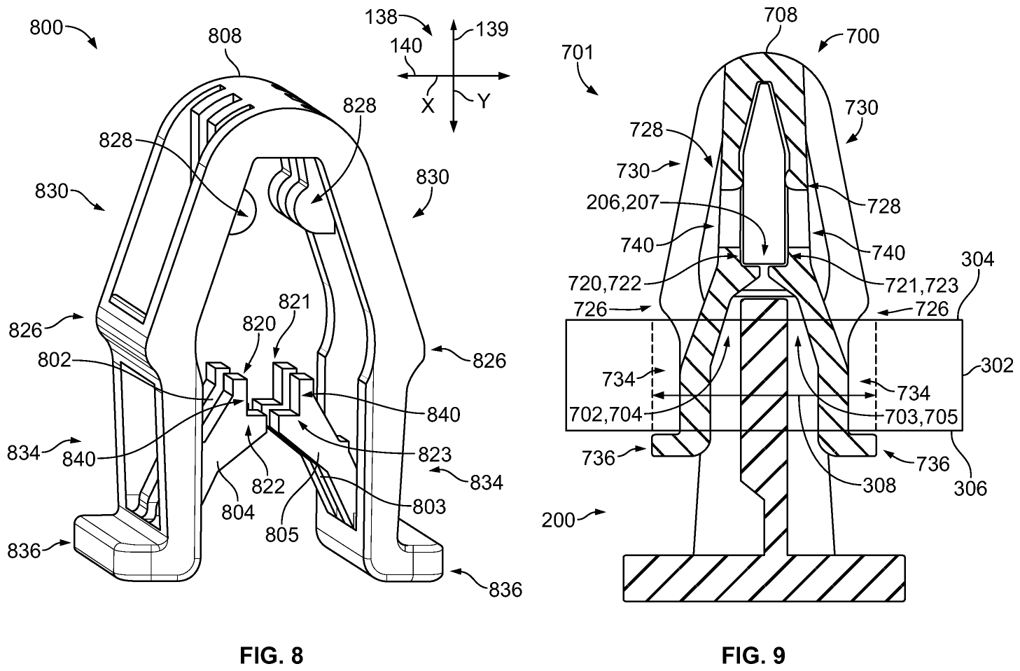

FIG. 8 illustrates a lateral perspective view of a retaining clip 800, according to an embodiment of the represent disclosure. The retaining clip 800 includes a nose 808. Extending from the nose 808 are opposing beams 830. The beams 830 extend outwardly relative to the nose 808. The beams 830 are shown having an oblong shape. For example, the beams 830 are shown extending further along the Y-direction 139 relative to the X-direction 140 of the Cartesian coordinates 138. The oblong shape of the beams 830 allows the retaining clip 800 to extend along a rib member 200. The oblong shape of the beams 830 allows the legs 802-805 to enter retaining holes 206, 207 of the rib member 200 (FIG. 2). For example, the oblong shape of the beams 830 allows the rib member 200 to enter the rib clip assembly 800.

Extending from the nose 808 are stoppers 828. The stoppers 828 are configured to abut the edge 210 of the rib member 200 (FIG. 2) to prevent vibration rattling. The stoppers 828 extend from the nose 808 along the Y-direction 139 towards the legs 802-805.

The beams 830 extend to form compression regions 834. Interposed between the protrusions 826 and protrusions 836 is the compression regions 834. Extending from the protrusions 836 are the legs 802-805. The legs 802-805 are spaced apart from each other and directed towards the nose 808. The legs 802-805 are directed laterally away from the protrusions 836. For example, the legs 802-805 are directed diagonally relative to the X-direction 140 and the Y-direction 139 towards the nose 808.

The legs 802-805 include receptacle indentations 820-823. The indentations 820-823 represent L-shaped cutouts and/or orthogonal angles cutouts of the legs 802-805. The indentations 820-823 are configured to enter the holes 206, 207 of the rib member 200 (FIG. 2). For example, the indentations 820-823 are configured to be positioned within the holes 206, 207. Responsive to the indentations 820-823 within the holes 206, 207, the indentations 820-823 are secured to the rib member 200 to form a rib clip assembly. For example, the indentations 820-823 enable the legs 802-805 to be coupled to the rib member 200. The indentations 820-823 include an extension 840 along the Y-direction 139. The extension 840 is configured to align along the width 312 (FIG. 3) of the rib member 200. The extension 840 can be configured to prevent lateral motion of the retaining clip 800 relative to the rib member 200.

The regions 834 allow the rib clip assembly 800 to be removed from the rib member 200. For example, responsive to forces applied away from the centerline 208 of the rib member 200 at the regions 834 along the X-direction 140, the indentations 820-823 of the legs 802-805 are retracted from the holes 206, 207. The opposing forces expand the legs 802-805 apart from each other. The legs 802-805 separate with respect to each other. For example, a distance between the legs 802-805 is expanded outside the width 312 of the rib member 200. The spacing of the legs 802-805 from the holes 206, 207 allows the legs 802-805 not to be obstructed by the holes 206, 207. The retraction of the indentations 820-823 from the holes 206, 207 allow the rib clip assembly 800 to be removed from the rib member 200.

FIG. 9 illustrates a lateral view of the rib clip assembly 701 including the retaining clip 700, according to an embodiment of the present disclosure. For example, the retaining clip 700 is positioned over the rib member 200 such that the indentations 720-723 are positioned within the holes 206, 207. The indentations 720-723 are configured to couple the legs 702-705 to the rib member 200. For example, the indentations 720-723 are configured to lock the legs 702-705 of the retaining clip 700 to the rib member 200.

Additionally, the component 302 may include a sheet metal and/or a plastic panel. Optionally, more than one panel may be utilized. The component 302 includes a window 308. The window 308 is typically rectangular having dimensions that are complementary to the retaining clip 700. For example, the dimensions of the window 308 are configured to allow the retaining clip 100 to pass through the window 308 along the Y-direction 139. A thickness 310 of the component 302 is configured to be between the retention edges 726 and 736.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontally becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Various features of the disclosure are set forth in the following claims.

1. A retaining clip, comprising:
a nose;
opposing beams extending from the nose, wherein the opposing beams have an oblong shape, the opposing beams forming compression regions; and
retaining legs extending from the compression regions, wherein the retaining legs are configured to be spaced apart from each other.

2. The retaining clip of claim 1, wherein the retaining legs extend towards the nose.

3. The retaining clip of claim 1, wherein the retaining legs include receptacle indentations, the receptacle indentations including orthogonal angle cutouts at distal ends of the retaining legs.

4. The retaining clip of claim 3, wherein the receptacle indentations are configured to be received by retaining holes of a rib member.

5. The retaining clip of claim 4, wherein the receptacle indentations reach the retaining holes of the rib member responsive to the retaining legs traversing along the rib member towards the retaining holes.

6. The retaining clip of claim 4, wherein the retaining holes are offset relative to a centerline of the rib member.

7. The retaining clip of claim 6, wherein the rib member includes weld lines that extend diagonally from an upper lateral portion of the retaining holes to an edge of the rib clip.

8. The retaining clip of claim 7, wherein the weld lines are configured such that extraction forces of the retaining legs are not exerted on the weld lines.

9. The retaining clip of claim 1, wherein stoppers are disposed along an internal face of the opposing beams, the stoppers are configured to abut an edge of a rib member.

10. The retaining clip of claim 1, wherein in response to the retaining legs traversing along a rib member the retainer legs are compressed by the rib member.

11. The retaining clip of claim 1, wherein the retaining legs are removed from retaining holes of a rib member in response to vector forces applied away from the centerline.

12. The retaining clip of claim 1, wherein the retaining legs of the retaining clip include a support connection that couples the retaining legs to the nose.

13. A rib clip assembly, comprising:
a retaining clip, the retaining clip includes a nose and opposing beams extending from the nose, wherein the opposing beams have an oblong shape, the opposing beams forming compression regions interposed between first and second protrusions, extending from the second protrusions are retaining legs, the retaining legs are configured to be spaced apart from each other; and
a rib member that includes retaining holes offset relative to a centerline of the rib member, wherein the rib member includes weld lines that extend diagonally from an upper lateral portion of the retaining holes to an edge of the rib member.

14. The rib clip assembly of claim 14, wherein the retaining legs of the retaining clip include a support connection that couples the retaining legs to the nose.

15. The rib clip assembly of claim 15, wherein stoppers are disposed on the support connection, wherein the stoppers are configured to abut the edge of the rib member.

16. The rib clip assembly of claim 14, wherein stoppers extend from the nose of the retaining clip, wherein the stoppers are configured to abut the edge of the rib member.

17. The rib clip assembly of claim 14, wherein the retaining legs include receptacle indentations that are configured to enter the retaining holes of the rib member.

18. The rib clip assembly of claim 16, wherein the receptacle indentations include an extension extending along a width of the rib member.

19. The rib clip assembly of claim 14, wherein the retaining legs are removed from retaining holes of the rib member in response to vector forces applied away from the centerline.

20. A rib clip assembly, comprising:
a retaining clip, the retainig clip includes a nose and opposing beams extending from the nose, the opposing beams forming compression regions, wherein the opposing beams have an oblong shape, wherein stoppers are disposed along an internal face of the beams, wherein the stoppers are configured to abut an edge of a rib member, extending from the compression regions are retaining legs, the retaining legs are configured to be spaced apart from each other and extend towards the nose, the retaining legs include receptacle indentations, the receptacle indentations including orthogonal angles at distal ends of the retaining legs; and
the rib member having weld lines that extend diagonally from an upper lateral portion of retaining holes to an edge of the rib member, wherein the weld lines are configured such that extraction forces of the four retaining legs are not exerted on the weld lines, the rib clip having the retaining holes that are offset relative to a centerline of the rib member, wherein the retaining legs are removed from the retaining holes of the rib member in response to vector forces applied away from the centerline.
